(19) United States
(12) Patent Application Publication
(10) Pub. No.: US 2022/0230100 A1
(43) Pub. Date: Jul. 21, 2022

(54) CONTROL DEVICE, SYSTEM, AND PROPOSITION METHOD

(71) Applicant: TOYOTA JIDOSHA KABUSHIKI KAISHA, Toyota-shi (JP)

(72) Inventors: Yui SUGIE, Nagoya-shi (JP); Hikaru GOTOH, Nagoya-shi (JP); Hiroki KIDO, Miyoshi-shi (JP); Shuichi SAWADA, Nagoya-shi (JP); Genshi KUNO, Kasugai-shi (JP); Katsuhiro OHARA, Nagoya-shi (JP)

(73) Assignee: TOYOTA JIDOSHA KABUSHIKI KAISHA, Toyota-shi (JP)

(21) Appl. No.: 17/568,787

(22) Filed: Jan. 5, 2022

(30) Foreign Application Priority Data
Jan. 21, 2021 (JP) 2021-008294

(51) Int. Cl. G06Q 10/02

(52) U.S. Cl. CPC G06Q 10/02; G06Q 2240/00

(57) ABSTRACT

The control device includes: a communication unit that communicates with a terminal device used by a user; and a control unit that searches a database in which data indicating an environment of each of a plurality of areas is registered by using condition data indicating a condition of a surrounding environment when the user stays in a vehicle as a search key, that selects at least one area among the areas as a parking area based on an acquired search result, and that causes the communication unit to transmit proposition data that proposes the user to park the vehicle in the parking area that is selected.

### CROSS-REFERENCE TO RELATED APPLICATION

This application claims priority to Japanese Patent Application No. 2021-008294 filed on Jan. 21, 2021, incorporated herein by reference in its entirety.

### BACKGROUND

### 1. Technical Field

The present disclosure relates to a control device, a system, and a proposition method.

### 2. Description of Related Art

Japanese Unexamined Patent Application Publication No. 2013-113070 (JP 2013-113070 A) discloses a building containing a vehicle having a container portion for a person to take shelter in the event of a disaster.

### SUMMARY

Depending on the parking place, it may not be possible to ensure the safety or security of people taking shelter in the vehicle. That is, there are parking places that are not suitable for taking shelter in the vehicle.

An object of the present disclosure is to propose a parking area that is suitable when staying in a vehicle.

A control device according to the present disclosure includes: a communication unit that communicates with a terminal device used by a user; and a control unit that searches a database in which data indicating an environment of each of a plurality of areas is registered by using condition data indicating a condition of a surrounding environment when the user stays in a vehicle as a search key, that selects at least one area among the areas as a parking area based on an acquired search result, and that causes the communication unit to transmit proposition data that proposes the user to park the vehicle in the parking area that is selected.

A proposition method according to the present disclosure includes: searching with a control device, a database in which data indicating an environment of each of a plurality of areas is registered by using condition data indicating a condition regarding a surrounding environment when a user stays in a vehicle as a search key; selecting with the control device, at least one area from the areas as a parking area, based on an acquired search result; and transmitting from the control device to a terminal device used by the user, proposition data proposing to the user to park the vehicle in the parking area that is selected.

According to the present embodiment, it is possible to propose a parking area that is suitable when staying in the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of a system according to an embodiment of the present disclosure;

FIG. 2 is a table showing an example of data registered in a database according to the embodiment of the present disclosure;

FIG. 3 is a block diagram showing a configuration of a control device according to the embodiment of the present disclosure;

FIG. 4 is a block diagram showing a configuration of a terminal device according to the embodiment of the present disclosure;

FIG. 5 is a flowchart showing operation of the control device according to the embodiment of the present disclosure; and

FIG. 6 is a flowchart showing operation of the terminal device according to the embodiment of the present disclosure.

### DETAILED DESCRIPTION OF EMBODIMENTS

Hereinafter, embodiments of the present disclosure will be described below with reference to the drawings.

In each drawing, the same or corresponding portions are denoted by the same reference signs. In the description of each embodiment, description of the same or corresponding components will be appropriately omitted or simplified.

An embodiment of the present disclosure will be described.

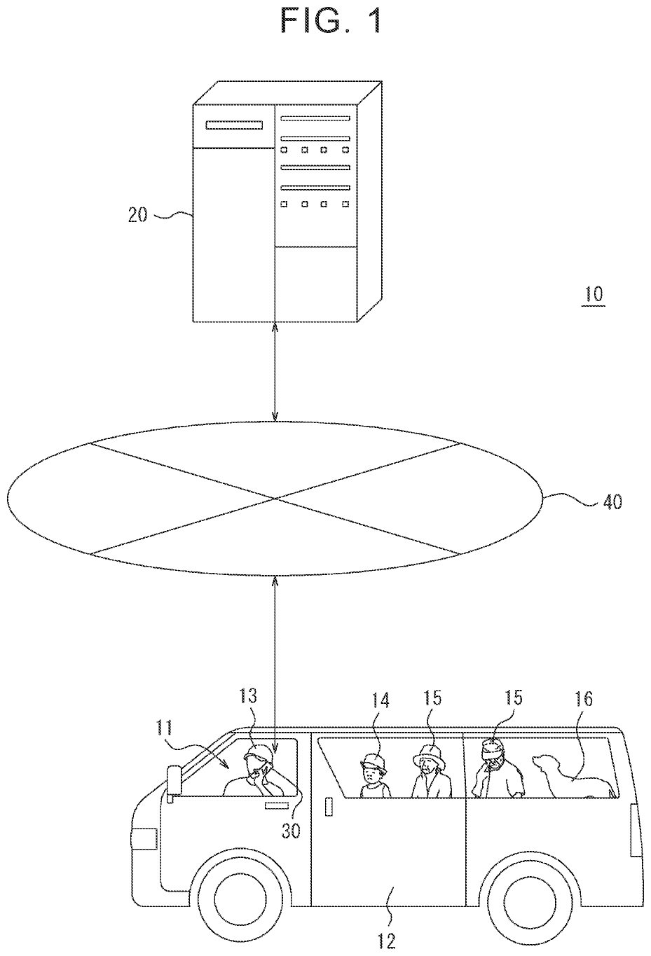

The configuration of a system 10 according to the present embodiment will be described with reference to FIG. 1.

The system 10 according to the present embodiment includes at least one control device 20, and at least one terminal device 30. The control device 20 can communicate with the terminal device 30 via a network 40.

The control device 20 is installed in facilities such as a data center. The control device 20 is, for example, a computer such as a server belonging to a cloud computing system or other computing systems.

The terminal device 30 is used by a user 13. For example, the terminal device 30 is a mobile device such as a mobile phone, a smartphone, or a tablet, and is held by the user 13. Alternatively, the terminal device 30 is an in-vehicle device such as a car navigation device, and is mounted on a vehicle 12. The user 13 is a member of a family 11 who are staying in the vehicle 12. In the example shown in FIG. 1, the family 11 has one child 14, two elderly people 15, and one pet 16. The user 13 is a parent of the child 14, a child of the elderly people 15, and an owner of the pet 16.

The network 40 includes the Internet, at least one WAN, at least one MAN, or any combination thereof. The term “WAN” is an abbreviation for “wide area network”. The term “MAN” is an abbreviation for “metropolitan area network”. The network 40 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation for “local area network”.

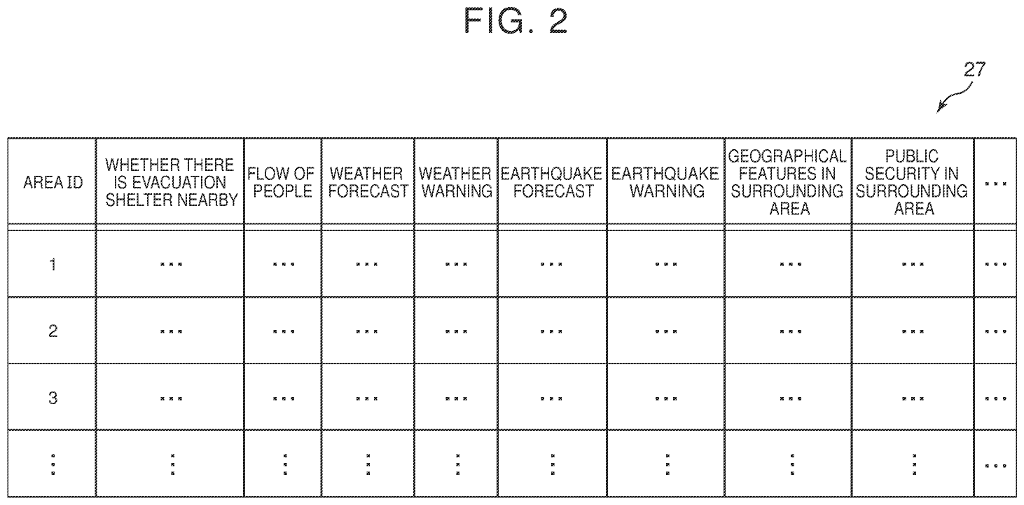

The outline of the present embodiment will be described with reference to FIGS. 1 and 2.

The terminal device 30 transmits data such as status data D1 to the control device 20. The status data D1 is data indicating the support status of the user 13 at the time of a disaster.

The control device 20 receives data such as the status data D1 from the terminal device 30. The control device 20 sets condition data D2 based on the received data. The condition data D2 is data indicating conditions regarding the surrounding environment when the user 13 stays in the vehicle 12. The control device 20 searches a database 27 using the set condition data D2 as a search key. Data indicating the environment of each of a plurality of areas is registered in the database 27. The control device 20 selects at least one area from the plurality of areas as the parking area, based on the acquired search results. In the present embodiment, the data registered in the database 27 includes data indicating whether there is an evacuation shelter near each of the areas. When setting the condition data D2, the control device 20 determines whether to include the presence of an evacuation shelter in the vicinity in the condition indicated by the condition data D2 in accordance with the situation indicated by the received status data D1. For example, when the status data D1 indicates that the support for the user 13 is insufficient, the status indicating that there is an evacuation shelter in the vicinity is included in the condition indicated by the condition data D2. As a result, an area with an evacuation shelter in the vicinity is selected as the parking area. The control device 20 transmits proposition data D3 to the terminal device 30. The proposition data D3 is data that proposes to the user 13 to park the vehicle 12 in the selected parking area.

The terminal device 30 receives the proposition data D3 from the control device 20. The terminal device 30 prompts the user 13 to park the vehicle 12 in the selected parking area by proposing the received proposition data D3.

According to this embodiment, it is possible to propose a parking area suitable for staying in the vehicle 12. For example, if the support for the user 13 is insufficient, an area with an evacuation shelter in the vicinity can be proposed as a parking area. The user 13 can easily receive support by parking the vehicle 12 in an area where there is an evacuation shelter in the vicinity. As a result, the safety and security of the user 13 is ensured.

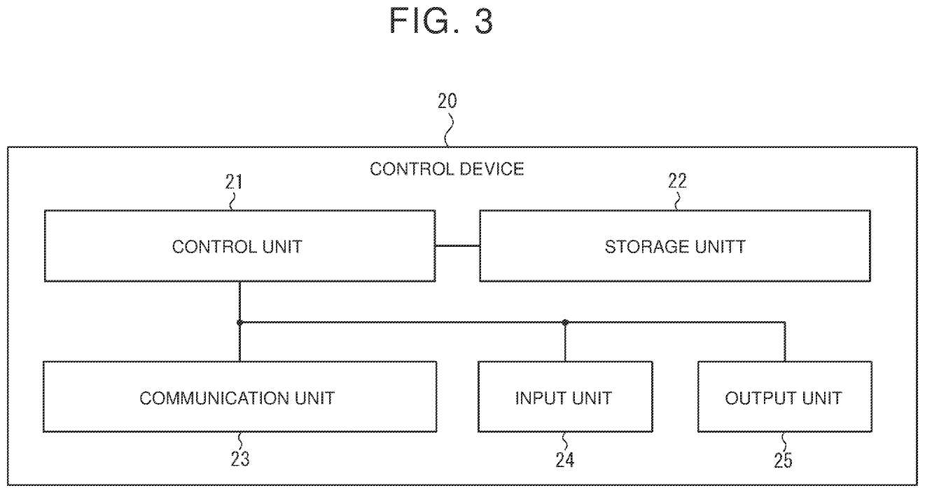

The configuration of the control device 20 according to the present embodiment will be described with reference to FIG. 3.

The control device 20 includes a control unit 21, a storage unit 22, a communication unit 23, an input unit 24, and an output unit 25.

The control unit 21 includes at least one processor, at least one programmable circuit, at least one dedicated circuit, or any combination thereof. The processor is a general-purpose processor such as a CPU or GPU, or a dedicated processor specialized for a specific process. The term “CPU” is an abbreviation for “central processing unit”. The term “GPU” is an abbreviation for “graphics processing unit”. The programmable circuit is, for example, an FPGA. The term “FPGA” is an abbreviation for “field-programmable gate array”. The dedicated circuit is, for example, an ASIC. The term “ASIC” is an abbreviation for “application specific integrated circuit”. The control unit 21 performs processes related to the operation of the control device 20 while controlling each unit of the control device 20.

The storage unit 22 includes at least one semiconductor memory, at least one magnetic memory, at least one optical memory, or any combination thereof. The semiconductor memory is, for example, a RAM or a ROM. The term “RAM” is an abbreviation for “random access memory”. The term “ROM” is an abbreviation for “read only memory”. The RAM is, for example, an SRAM or a DRAM. The term “SRAM” is an abbreviation for “static random access memory”. The term “DRAM” is an abbreviation for “dynamic random access memory”. The ROM is, for example, an EEPROM. The term “EEPROM” is an abbreviation for “electrically erasable programmable read only memory”. The storage unit 22 functions as, for example, a main storage device, an auxiliary storage device, or a cache memory. The storage unit 22 stores data used for the operation of the control device 20 and data acquired through the operation of the control device 20. Although the database 27 is built in the storage unit 22 in this embodiment, it may be built in an external storage and connected to the control device 20.

The communication unit 23 includes at least one communication interface. The communication interface is, for example, a LAN interface. The communication unit 23 receives the data used for the operation of the control device 20, and transmits the data acquired through the operation of the control device 20.

The input unit 24 includes at least one input interface. The input interface is, for example, a physical key, a capacitive key, a pointing device, a touch screen integrated with a display, a camera, or a microphone. The input unit 24 accepts an operation of inputting data used for the operation of the control device 20. The input unit 24 may be connected to the control device 20 as an external input device instead of being provided in the control device 20. As the connection interface, for example, an interface corresponding to a standard such as USB, HDMI (registered trademark), or Bluetooth (registered trademark) can be used. The term “USB” is an abbreviation for “universal serial bus”. The term “HDMI (registered trademark)” is an abbreviation for “high-definition multimedia interface”.

The output unit 25 includes at least one output interface. The output interface is, for example, a display or a speaker. The display is, for example, an LCD or an organic EL display. The term “LCD” is an abbreviation for “liquid crystal display”. The term “EL” is an abbreviation for “electroluminescence”. The output unit 25 outputs the data acquired through the operation of the control device 20. The output unit 25 may be connected to the control device 20 as an external output device instead of being provided in the control device 20. As the connection interface, for example, an interface corresponding to a standard such as USB, HDMI (registered trademark), or Bluetooth (registered trademark) can be used.

The function of the control device 20 is realized by executing the control program according to the present embodiment with the processor serving as the control unit 21. That is, the function of the control device 20 is realized by software. The control program causes the computer to perform the operation of the control device 20 so that the computer functions as the control device 20. That is, the computer functions as the control device 20 by performing the operation of the control device 20 according to the control program.

The program can be stored in a non-transitory computer-readable medium. The non-transitory computer-readable medium is, for example, a flash memory, a magnetic recording device, an optical disc, an opto-magnetic recording medium, or a ROM. The distribution of the program is carried out, for example, by selling, transferring, or renting a portable medium such as am SD card, a DVD, or a CD-ROM in which the program is stored. “SD” is an abbreviation for “secure digital”. The term “DVD” is an abbreviation for “digital versatile disc”. The term “CD-ROM” is an abbreviation for “compact disc read only memory”. The program may be stored in the storage of the server and transferred from the server to other computers to distribute the program. The program may be provided as a program product.

The computer temporarily stores the program stored in the portable medium or the program transferred from the server in the main storage device, for example. Then, the computer causes the processor to read the program stored in the main storage device, and causes the processor to perform processes according to the read program. The computer may read the program directly from the portable medium and perform processes according to the program. The computer may perform the processes according to the received program each time the program is transferred from the server to the computer. The processes may be executed by a so-called ASP service that realizes the function only by execution instruction and result acquisition without transferring the program from the server to the computer. The term “ASP” is an abbreviation for “application service provider”. The program includes information that is used for processing by electronic computers and equivalent to a program. For example, data that is not a direct command to a computer but has the property of defining the processing of the computer corresponds to the “data equivalent to a program”.

A part or all of the functions of the control device 20 may be realized by a programmable circuit or a dedicated circuit as the control unit 21. That is, a part or all of the functions of the control device 20 may be realized by hardware.

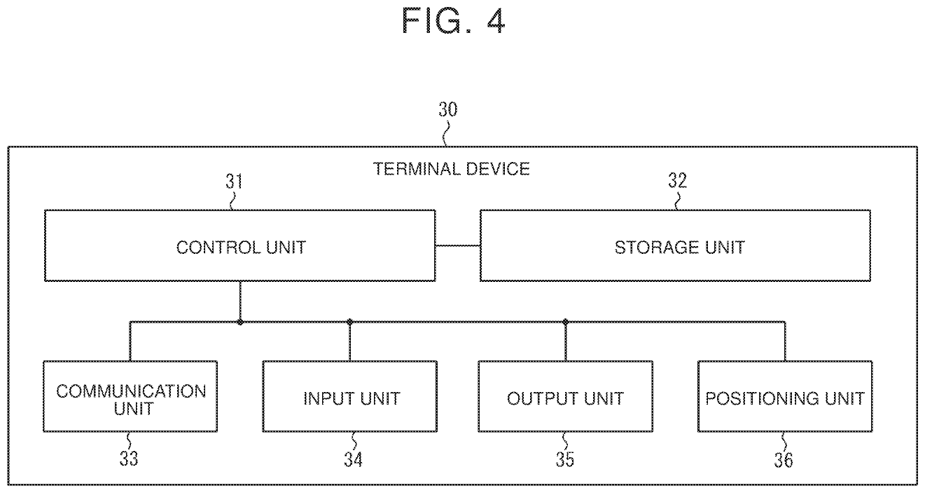

The configuration of the terminal device 30 according to the present embodiment will be described with reference to FIG. 4.

The terminal device 30 includes a control unit 31, a storage unit 32, a communication unit 33, an input unit 34, an output unit 35, and a positioning unit 36.

The control unit 31 includes at least one processor, at least one programmable circuit, at least one dedicated circuit, or any combination thereof. The processor is a general-purpose processor such as a CPU or GPU, or a dedicated processor specialized for a specific process. The programmable circuit is, for example, an FPGA. The dedicated circuit is, for example, an ASIC. The control unit 31 performs the processes related to the operation of the terminal device 30 while controlling each unit of the terminal device 30.

The storage unit 32 includes at least one semiconductor memory, at least one magnetic memory, at least one optical memory, or any combination thereof. The semiconductor memory is, for example, a RAM or a ROM. The RAM is, for example, a SRAM or a DRAM. The ROM is, for example, an EEPROM. The storage unit 32 functions as, for example, a main storage device, an auxiliary storage device, or a cache memory. The storage unit 32 stores data used for the operation of the terminal device 30 and data acquired through the operation of the terminal device 30.

The communication unit 33 includes at least one communication interface. The communication interface is, for example, an interface compatible with mobile communication standards such as LTE, 4G standard, or 5G standard, an interface compatible with short-range wireless communication standard such as Bluetooth (registered trademark), or a LAN interface. The term “LTE” is an abbreviation for “long term evolution”. The term “4G” is an abbreviation for “fourth generation”. The term “5G” is an abbreviation for “fifth generation”. The communication unit 33 receives the data used for the operation of the terminal device 30, and transmits the data acquired through the operation of the terminal device 30.

The input unit 34 includes at least one input interface. The input interface is, for example, a physical key, a capacitive key, a pointing device, a touch screen integrated with a display, a camera, or a microphone. The input unit 34 accepts an operation of inputting data used for the operation of the terminal device 30. The input unit 34 may be connected to the terminal device 30 as an external input device instead of being provided in the terminal device 30. As the connection interface, for example, an interface corresponding to a standard such as USB, HDMI (registered trademark), or Bluetooth (registered trademark) can be used.

The output unit 35 includes at least one output interface. The output interface is, for example, a display or a speaker. The display is, for example, an LCD or an organic EL display. The output unit 35 outputs the data acquired through the operation of the terminal device 30. The output unit 35 may be connected to the terminal device 30 as an external output device instead of being provided in the terminal device 30. As the connection interface, for example, an interface corresponding to a standard such as USB, HDMI (registered trademark), or Bluetooth (registered trademark) can be used.

The positioning unit 36 includes at least one GNSS receiver. The term “GNSS” is an abbreviation for “global navigation satellite system”. The GNSS is, for example, GPS, QZSS, BDS, GLONASS, or Galileo. The term “GPS” is an abbreviation for “global positioning system”. The term “QZSS” is an abbreviation for “quasi-zenith satellite system”. The satellites of the QZSS are referred to as quasi-zenith satellites. The term “BDS” is an abbreviation for “BeiDou navigation satellite system”. The term “GLONASS” is an abbreviation for “global navigation satellite system”. The positioning unit 36 measures the position of the terminal device 30.

The function of the terminal device 30 is realized by executing the terminal program according to the present embodiment with the processor corresponding to the control unit 31. That is, the function of the terminal device 30 is realized by software. The terminal program causes the computer to perform the operation of the terminal device 30 so that the computer functions as the terminal device 30. That is, the computer functions as the terminal device 30 by performing the operation of the terminal device 30 according to the terminal program.

A part or all of the functions of the terminal device 30 may be realized by a programmable circuit or a dedicated circuit as the control unit 31. That is, a part or all of the functions of the terminal device 30 may be realized by hardware.

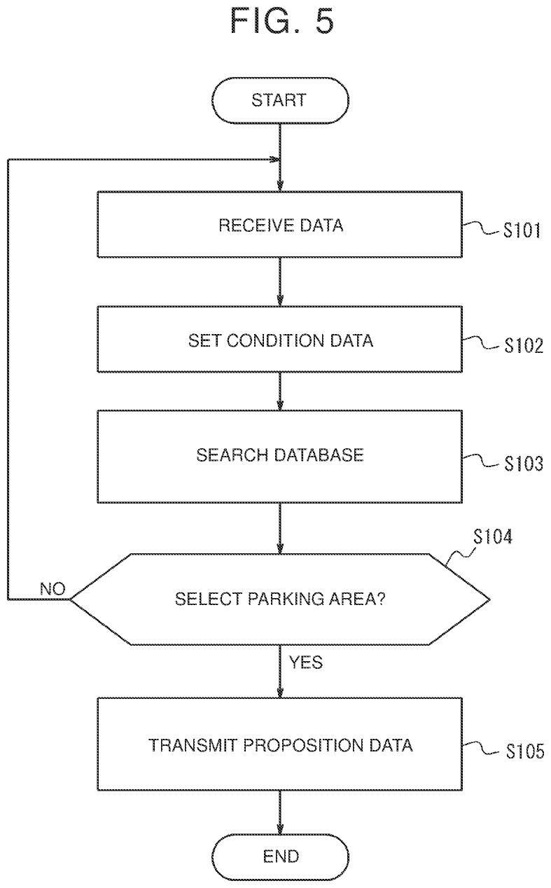

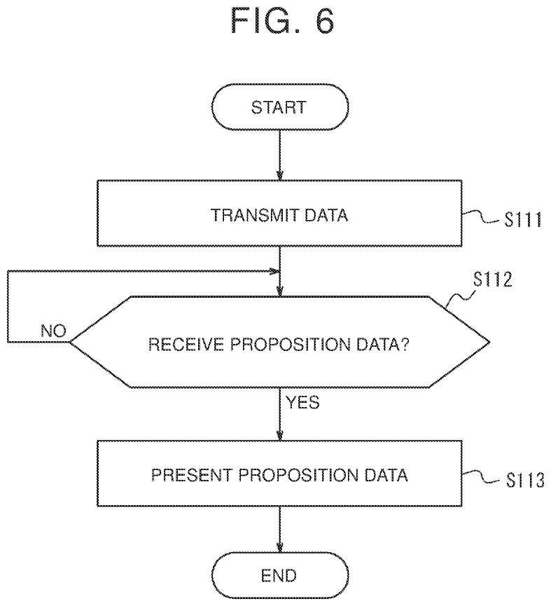

The configuration of a system 10 according to the present embodiment will be described with reference to FIG. 5 and FIG. 6. The operation corresponds to the proposition method according to the present embodiment. FIG. 5 shows the operation of the control device 20. FIG. 6 shows the operation of the terminal device 30.

In step S111 of FIG. 6, the control unit 31 of the terminal device 30 receives from the user 13, an operation of inputting the support status of the user 13 at the time of a disaster via the input unit 34. The control unit 31 causes the communication unit 33 to transmit data such as the status data D1. The status data D1 is data indicating the support status input by the user 13. The communication unit 33 transmits data such as the status data D1 to the control device 20.

In step S101 of FIG. 5, the communication unit 23 of the control device 20 receives the data transmitted in step S111 in FIG. 6 from the terminal device 30. The control unit 21 of the control device 20 acquires the data received by the communication unit 23.

In step S102 of FIG. 5, the control unit 21 of the control device 20 sets the condition data D2 based on the data acquired in step S101. The condition data D2 is data indicating conditions regarding the surrounding environment when the user 13 stays in the vehicle 12. In the present embodiment, the control unit 21 determines whether to include that there is an evacuation shelter in the vicinity in the condition indicated by the condition data D2, in accordance with the status indicated by the status data D1 included in the data acquired in step S101. Specifically, when the status data D1 indicates that the support for the user 13 is insufficient, the control unit 21 includes that there is an evacuation shelter in the vicinity in the condition indicated by the condition data D2.

In step S103 of FIG. 5, the control unit 21 of the control device 20 searches the database 27 using the condition data D2 set in step S102 as a search key. Data indicating the environment of each of a plurality of areas is registered in the database 27. In the present embodiment, the data registered in the database 27 includes data indicating whether there is an evacuation shelter near each of the areas, as shown in FIG. 2.

In step S104 in FIG. 5, the control unit 21 of the control device 20 selects at least one area from the plurality of areas as the parking area based on the search result acquired in step S103. Specifically, the control unit 21 selects as the parking area, an area indicated by the data registered in the database 27 that the condition indicated by the condition data D2 is satisfied. When the condition includes that there is an evacuation shelter in the vicinity, the control unit 21 selects an area where there is an evacuation shelter in the vicinity as a parking area. If the number of search results is 0, that is, there is no selectable area, the processes after step S101 are executed again.

In step S105 of FIG. 5, the control unit 21 of the control device 20 causes the communication unit 23 to transmit the proposition data D3. The proposition data D3 is data that proposes to the user 13 to park the vehicle 12 in the parking area selected in step S104. The proposition data D3 may include data for notifying the user 13 of a location such as coordinates or an address of a parking area. The communication unit 23 transmits the proposition data D3 to the terminal device 30.

After step S111 in FIG. 6, the terminal device 30 is on standby until the parking area is selected by the control device 20. When the parking area is selected by the control device 20, in step S112, the communication unit 33 of the terminal device 30 receives the proposition data D3 transmitted in step S105 in FIG. 5 from the control device 20. The control unit 31 of the terminal device 30 acquires the proposition data D3 received by the communication unit 33.

In step S113 of FIG. 6, the control unit 31 of the terminal device 30 prompts the user 13 to park the vehicle 12 in the selected parking area by presenting the proposition data D3 acquired in step S112. Specifically, the control unit 31 displays the content of the proposition data D3 on the display serving as the output unit 35. Alternatively, the control unit 31 outputs the content of the proposition data D3 by voice from the speaker serving as the output unit 35.

As described above, in the present embodiment, the communication unit 23 of the control device 20 communicates with the terminal device 30 used by the user 13. The control unit 21 of the control device 20 searches the database 27 in which the data indicating the environment of each of the plurality of areas is registered, in which the condition data D2 indicating the condition regarding the surrounding environment when the user 13 stays in the vehicle 12 serves as the search key. The control unit 21 selects at least one area from the plurality of areas as the parking area based on the acquired search results. The control unit 21 causes the communication unit 23 to transmit the proposition data D3 that proposes to the user 13 to park the vehicle 12 in the selected parking area. Therefore, according to the present embodiment, it is possible to propose a parking area suitable for staying in the vehicle 12.

In the present embodiment, as shown in FIG. 2, data indicating whether there is an evacuation shelter near each of the areas is registered in the database 27 in a table format. However, as a modification of the present embodiment, such data may be registered in the database 27 in the form of a map. For example, map data indicating the location of each of the areas and the location of at least one evacuation shelter may be registered in the database 27. In that case, in step S103 and step S104 of FIG. 5, the control unit 21 of the control device 20 searches the map data and extracts as a parking area, an area satisfying the condition indicated by the condition data D2. Specifically, the control unit 21 calculates the distance between each of the areas and the evacuation shelter. Assuming that the upper limit of the distance from the evacuation shelter is included in the condition, the control unit 21 extracts as the parking area, the area where the calculated distance is equal to or less than the upper limit.

In the present embodiment, the parking area is selected in accordance with the support status of the user 13 at the time of a disaster. However, as a modification of the present embodiment, the parking area may be selected in accordance with a family structure of the user 13 instead of the support status or together with the support status. In such a modified example, as shown in FIG. 2, data indicating the flow of people in each of the areas may be registered in the database 27. For example, the data of the flow of people provided by a mobile communication operator may be registered in the database 27. In that case, in step S111 of FIG. 6, the control unit 31 of the terminal device 30 receives an operation of inputting the family structure of the user 13 from the user 13 via the input unit 34. The control unit 31 causes the communication unit 33 to transmit data such as the structure data D4. The structure data D4 is data indicating the family structure input by the user 13. The communication unit 33 transmits data such as the structure data D4 to the control device 20. In step S102 of FIG. 5, the control unit 21 of the control device 20 determines whether the upper limit of the number of people is included in the condition indicated in the condition data D2 in accordance with the family structure indicated in the structure data D4 included in the data acquired in step S101. Specifically, when the structure data D4 indicates that a child or a pet is included in the family 11 of the user 13, the control unit 21 includes the upper limit of the number of people in the condition indicated by the condition data D2. When the upper limit of the number of people is included in the condition, in step S104, the control unit 21 selects as the parking area, an area where the number of people is equal to or less than the upper limit.

According to this modification, if a child or a pet is included in the family 11 of the user 13, an area with few people can be proposed as a parking area. In the example shown in FIG. 1, it becomes easier for the user 13 to secure privacy by parking the vehicle 12 in an area with few people, and it becomes easier to take care of the child 14 and the pet 16. As a result, the safety and security of the user 13 is ensured.

In the present embodiment, the condition data D2 is set based on the data from the terminal device 30. However, as a modification of the present embodiment, instead of the data from the terminal device 30, or with the data from the terminal device 30, the condition data D2 may be set based on the data that specifies the condition to be set. That is, the process of step S111 of FIG. 6 and step S101 of FIG. 5 may be omitted. As such a modified example, a first modified example, a second modified example, and a third modified example will be described.

In the first modification, as shown in FIG. 2, data indicating a weather forecast or a weather warning in each of the areas may be registered in the database 27. For example, weather forecast data or weather warning data provided by the Japan Meteorological Agency may be registered in the database 27. In that case, in step S102 of FIG. 5, the control unit 21 of the control device 20 includes the designated meteorological condition in the condition indicated by the condition data D2. When the upper limit of the temperature is included in the meteorological conditions, in step S104, the control unit 21 selects an area where the future or current temperature is equal to or lower than the upper limit as the parking area. When the lower limit of the temperature is included in the meteorological conditions, in step S104, the control unit 21 selects an area where the future or current temperature is equal to or higher than the lower limit as the parking area. When the upper limit of the snow accumulation amount is included in the meteorological conditions, in step S104, the control unit 21 selects an area where the snow accumulation amount in the future or the present is equal to or less than the upper limit as the parking area.

According to this modification, a cool area such as an area with a high altitude can be proposed as a parking area. By parking the vehicle 12 in a cool area, the user 13 is less likely to suffer from heat stroke. As a result, the safety and security of the user 13 is ensured. Alternatively, according to this modification, a warm area can be proposed as a parking area. The user 13 is less likely to suffer from hypothermia by parking the vehicle 12 in a warm area. As a result, the safety and security of the user 13 is ensured. Alternatively, according to this modification, an area with a small snow accumulation amount can be proposed as a parking area. If the vehicle 12 is buried in snow, the exhaust gas may enter the vehicle 12 and the user 13 may get carbon monoxide poisoning. By parking the vehicle 12 in an area with a small snow accumulation amount, such a status may can be avoided. As a result, the safety and security of the user 13 is ensured.

As shown in FIG. 2, data indicating the geographical features around each of the areas may be further registered in the database 27. For example, data of geographical features provided by the Geospatial Information Authority of Japan may be registered in the database 27. In that case, in step S102 of FIG. 5, the control unit 21 of the control device 20 further includes the designated geographical feature condition in the condition indicated by the condition data D2. When the upper limit of an amount of rainfall is included in the meteorological conditions, in step S104, the control unit 21 selects as a parking area, an area in which the future or current amount of rainfall is equal to or lower than the upper limit, or an area in which there is no geographical features in which a sediment-related disaster or flood may occur in the vicinity such as a cliff or a river.

According to this modification, it is possible to propose an area where disasters are unlikely to occur as a parking area. The user 13 can avoid a disaster by parking the vehicle 12 in an area where a disaster is unlikely to occur. As a result, the safety and security of the user 13 is ensured.

In the second modification, as shown in FIG. 2, an earthquake forecast or an earthquake warning of each of the areas, and the data indicating the geographical features around each of the areas may be registered in the database 27. For example, earthquake forecast data or earthquake warning data provided by the Japan Meteorological Agency, and data of geographical features provided by the Geospatial Information Authority of Japan may be registered in the database 27. In that case, in step S102 of FIG. 5, the control unit 21 of the control device 20 includes the upper limit of the magnitude of the designated earthquake and the designated geographical feature condition in the conditions shown in the condition data D2. In step S104, the control unit 21 selects as a parking area, an area where the magnitude of an earthquake that will occur in the future is equal to or less than the upper limit, or an area where there is no geographical features in which a landslide disaster or tsunami can occur in the vicinity such as a cliff or a coast.

According to this modification, it is possible to propose an area where disasters are unlikely to occur as a parking area. The user 13 can avoid a disaster by parking the vehicle 12 in an area where a disaster is unlikely to occur. As a result, the safety and security of the user 13 is ensured.

In the third modification, as shown in FIG. 2, data indicating the public security around each of the areas may be registered in the database 27. For example, crime statistical data provided by the Japanese National Police Agency may be registered in the database 27. In addition to past data such as crime statistical data, data acquired from the press may be used, or data acquired by predicting the probability of a crime occurring by machine learning may be used. In that case, in step S102 of FIG. 5, the control unit 21 of the control device 20 includes the upper limit of the designated degree of poor public security in the condition indicated by the condition data D2. In step S104, the control unit 21 selects an area in which the degree of poor public security is equal to or less than the upper limit as a parking area.

According to this modification, a safe area can be proposed as a parking area. By parking the vehicle 12 in a safe area, the user 13 is less likely to be involved in a crime. As a result, the safety and security of the user 13 is ensured.

According to the above-described embodiment including various modifications, it is possible to propose a suitable place to stay in the vehicle 12 depending on the status of the person staying in the vehicle 12 or the status of the surrounding environment. For example, it is possible to identify places to avoid, such as places with a large snow accumulation amount, places where oxygen deficiency is likely to occur such as indoors, places where rainfall is high, places where sediment-related disasters are likely to occur, places where a person is likely to get heat stroke, or crime-prone areas, and a place other than the specified place can be proposed.

As a modification of this embodiment, the communication unit 23 of the control device 20 may communicate with a terminal device used by each user of a plurality of users including the user 13. In such a modification, the control unit 21 of the control device 20 may set a parking position in the parking area where the distance to the other user is equal to or more than a threshold value for each user. The control unit 21 may cause the communication unit 23 to transmit data that proposes to each user to park the vehicle at the set parking position as the proposition data D3.

According to this moderation, when there are circumstances in which it is better not to have a dense population of users, such as when there is a possibility that anyone among the users generates noise, the parking positions may be proposed so that the parking positions of the users are dispersed.

The present disclosure is not limited to the embodiment described above. For example, two or more blocks shown in the block diagram may be integrated, or a single block may be divided. Instead of executing two or more steps shown in the flowcharts in chronological order according to the description, the steps may be executed in parallel or in a different order, depending on the processing capacities of the devices that execute the steps, or as necessary. Other changes may be made without departing from the scope of the present disclosure.

What is claimed is:

1. A control device comprising:
a communication unit that communicates with a terminal device used by a user; and
a control unit that searches a database in which data indicating an environment of each of a plurality of areas is registered by using condition data indicating a condition of a surrounding environment when the user stays in a vehicle as a search key, that selects at least one area among the areas as a parking area based on an acquired search result, and that causes the communication unit to transmit proposition data that proposes the user to park the vehicle in the parking area that is selected.

2. The control device according to claim 1,
wherein the communication unit receives status data indicating a support status of the user at a time of a disaster from the terminal device,
wherein the data registered in the database includes data indicating whether there is an evacuation shelter near each of the areas, and
wherein the control unit determines whether to include a presence of an evacuation shelter nearby in the condition indicated by the condition data in accordance with the status indicated by the status data received by the communication unit.

3. The control device according to claim 1,
wherein the communication unit receives structure data indicating a family structure of the user from the terminal device,
wherein data registered in the database includes data indicating a flow of people in each of the areas, and
wherein the control unit determines whether to include an upper limit of the number of people in the condition indicated by the condition data in accordance with the family structure indicated by the structure data received by the communication unit.

4. The control device according to claim 1,
wherein the data registered in the database includes data indicating a weather forecast or a weather warning of each of the areas, and
wherein the control unit includes a meteorological condition in the condition indicated by the condition data.

5. The control device according to claim 4, wherein the control unit includes an upper limit or a lower limit of a temperature in the meteorological condition.

6. The control device according to claim 4, wherein the control unit includes an upper limit or a lower limit of a snow accumulation amount in the meteorological condition.

7. The control device according to claim 4,
wherein the data registered in the database further includes data indicating geographical features around each of the areas, and
wherein the control unit includes an upper limit of an amount of rainfall in the meteorological condition and further includes a geographical feature condition in the condition indicated by the condition data.

8. The control device according to claim 1,
wherein the data registered in the database includes an earthquake forecast or an earthquake warning of each of the areas, and data indicating geographical features around each of the areas, and
wherein the control unit includes an upper limit of a magnitude of an earthquake and a geographical feature condition in the condition indicated by the condition data.

9. The control device according to claim 1,
wherein the data registered in the database further includes data indicating public security around each of the areas, and
wherein the control unit includes an upper limit of a degree of poor public security in the condition indicated by the condition data.

10. The control device according to claim 1,
wherein the communication unit communicates with a terminal device used by each of a plurality of users, and
wherein the control unit sets, for each of the users, a parking position in the parking area in which a distance between the parking position and another user is equal to or more than a threshold, and causes the communication unit to transmit, as the proposition data, data proposing to each of the users to park the vehicle in the parking position that is set.

11. A system comprising:
the control device according to claim 1; and
a terminal device.

12. A proposition method comprising:
searching with a control device, a database in which data indicating an environment of each of a plurality of areas is registered by using condition data indicating a condition regarding a surrounding environment when a user stays in a vehicle as a search key;
selecting with the control device, at least one area from the areas as a parking area, based on an acquired search result; and
transmitting from the control device to a terminal device used by the user, proposition data proposing to the user to park the vehicle in the parking area that is selected.

13. The proposition method according to claim 12, further comprising transmitting from the terminal device to the control device, status data indicating a support status of the user at a time of a disaster,
wherein the data registered in the database includes data indicating whether there is an evacuation shelter near each of the areas, and
wherein searching includes determining whether to include a presence of an evacuation shelter nearby in the condition indicated by the condition data in accordance with the status indicated by the status data.

14. The proposition method according to claim 12, further comprising transmitting structure data indicating a family structure of the user from the terminal device to the control device,
wherein the data registered in the database includes data indicating a flow of people in each of the areas, and
wherein searching includes determining whether to include an upper limit of the number of people in the condition indicated by the condition data in accordance with the family structure indicated by the structure data.

15. The proposition method according to claim 12,
wherein the data registered in the database includes data indicating a weather forecast or a weather warning of each of the areas; and
wherein the condition indicated by the condition data includes a meteorological condition.

16. The proposition method according to claim 15, wherein the meteorological condition includes an upper limit or a lower limit of a temperature.

17. The proposition method according to claim 15, wherein the meteorological condition includes an upper limit of a snow accumulation amount.

18. The proposition method according to claim 15,
wherein the data registered in the database further includes data indicating geographical features around each of the areas, and
wherein the meteorological condition includes an upper limit of an amount of rainfall, and
wherein the condition indicated by the condition data further includes a geographical feature condition.

19. The proposition method according to claim 12,
wherein the data registered in the database includes an earthquake forecast or an earthquake warning of each of the areas, and data indicating geographical features around each of the areas, and
wherein the condition indicated by the condition data includes an upper limit of a magnitude of an earthquake and a geographical feature condition.

20. The proposition method according to claim 12,
wherein the data registered in the database further includes data indicating public security around each of the areas, and
wherein the condition indicated by the condition data includes an upper limit of a degree of poor public security.
